(19) United States
(12) Patent Application Publication
(10) Pub. No.: US 2003/0166482 A1
(43) Pub. Date: Sep. 4, 2003

(54) Composition for stripping resists

(75) Inventors: Ho Sung Choi, Anyang-City (KR); Ji Hong Kim, Pyungtaek-City (KR); Tae Gewn Kim, Taejeon-City (KR); Sang Hyeuk Yeo, Ohsan-City (KR); Hae Sung Park, Ohsan-City (KR)

Correspondence Address: John S. Egbert, Harrison & Egbert, 7th Floor, 412 Main Street, Houston, TX, 77002, US

(73) Assignee: DUKSUNG Co., Ltd., Hwasung-City (KR)

(21) Appl. No.: 10/133,900

(22) Filed: Apr. 29, 2002

(30) Foreign Application Priority Data
Feb. 19, 2002 (JP) 2002-0008730

(51) Int. Cl. C11D 1/00

(52) U.S. Cl. 510/175; 510/176; 510/178; 510/499

(57) ABSTRACT

Disclosed is a stripping composition for removing resist, comprising 5-50% by weight of at least one product obtained from the reaction of alkyl acetoacetate or acetic acid with fatty acid amine, and 50-95% by weight of a solvent selected from the group consisting of water, an aqueous 25 wt % tetramethyl ammonium hydroxide solution, glycol, and organic polar solvents. The stripping composition is so excellent in terms of stripability as to require only a rinsing process with ultra-pure water without passing through a stripping composition removal process with an air knife and a rinsing process with isopropyl alcohol. Also, with low volatility and toxicity, the composition produces as little pollution of the environment as possible, in addition to not encroaching on metal undercoats and pipe substrates such as O-rings, even without corrosion preventives.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a composition for stripping resists modified by etching, ashing and/or ion implantation processes during the fabrication of semiconductor devices and liquid crystal displays.

### BACKGROUND OF THE INVENTION

On the whole, stripping compositions for removing resists are required to be excellent in terms of solvability and stripability for resists and neither corrode undercoats, especially metal undercoats, nor damage substrates such as O-rings and pipes.

Typically, a stripping composition is composed of a salt capable of dissolving resists, and a solvent.

Conventionally, organic amines such as monoethanol amine, and glycols or polar solvents are employed in stripping solutions, as disclosed in Japanese Pat. Laid-Open Publication Nos. Sho. 63-231343 and Hei. 4-124668 and U.S. Pat. No. 4,770,713.

However, the insufficient stripability of the stripping solutions causes the problem that, as the quantity of the objects treated increases, more resist particles remain unsolved, deteriorating the yield. On the other hand, the stripping solutions whose stripability is increased may corrode metal undercoats or damage O-rings or pipe substrates.

Stripping compositions for use in the fabrication of semiconductor devices employ, for the most part, expensive hydroxyl amine and erosion preventors for protection of metal undercoats, as disclosed in Japanese Pat. Laid-Open Publication No. Hei. 9-96911. In the case of using hydroxyalkane amide, heating at 80-90° C. for 5 hours is required to obtain amide reactants. Additionally, the alcohols produced must be removed by, for example, fractional distillation, which requires expensive erosion preventives such as catechol.

### BRIEF SUMMARY OF THE INVENTION

Leading to the present invention, the intensive and thorough research into stripping compositions, conducted by the present inventors, resulted in the finding that a product obtained from the reaction of alkyl acetoacetate or acetic acid with fatty acid amine can function as a solubilizer for dissolving resists at high efficiency without producing problems including corrosion of undercoats and encroachment on substrates themselves.

Therefore, it is an object of the present invention to provide a composition for stripping resists, which exhibits excellent stripability without damage to undercoats, O-rings and pipe substrates.

### BRIEF DESCRIPTION OF THE SEVERAL VIEWS OF THE DRAWINGS

FIG. 1 provides scanning electron microphotographs of a resist-coated glass substrate before stripping (a) and after stripping with the stripping composition of Example 1 of the present invention (b) and with the stripping composition of Comparative Example 2 (c), from which stripping performances of the stripping compositions are evaluated.

FIG. 2 provides scanning electron microphotographs of a PVC pipe specimen before being immersed in stripping compositions (a) and after being immersed in the stripping composition of Example 1 of the present invention (b) and in the stripping composition of Comparative Example 1, from which stripping compositions are evaluated for encroachment on PVC pipe substrates.

FIG. 3 provides scanning electron microphotographs of an O-ring specimen (made of perfluoroethylene) before being immersed in stripping compositions and after being immersed in the stripping composition of Example 1 of the present invention (b) and in the stripping composition of Comparative Example 1, from which stripping compositions are evaluated for encroachment on O-rings.

FIG. 4 provides scanning electron microphotographs of a resist-coated silicon wafer substrate before stripping (a) and after stripping with the stripping composition of Example 14 of the present invention (b) and with the stripping composition of Comparative Example 5 (c), from which the stripping compositions are evaluated for stripability against resist and corrosion on silicon wafers.

### DETAILED DESCRIPTION OF THE INVENTION

The present invention pertains to a composition for use in removing resists. During the fabrication of semiconductor devices and liquid crystal displays, resists are modified by etching, ashing, and ion implantation processes, and required to be removed.

In general, a composition for stripping resists comprises a salt for dissolving resists (resist solubilizer) and a solvent. The composition of the present invention employs as a resist solubilizer a product from the reaction of alkyl acetoacetate or acetic acid with fatty acid amine, and a solvent selected from among water, an aqueous 25 wt % tetramethyl ammonium hydroxide solution, glycol and organic polar compounds. If necessary, the composition of the present invention may be used in combination with a resist solubilizer well known in the art, such as mono ethanol amine, or an acid such as sulfuric acid and nitric acid, or combination thereof.

Alkyl acetoacetate and acetic acid, both used for preparing a salt as a resist solubilizer, are characterized by alkoxyaceto moieties (ROCO—, wherein R is a methyl or an ethyl group), as exemplified by the structural formulas

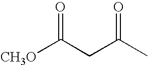

for methyl acetoacetate,

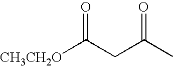

for ethyl acetoacetate, and

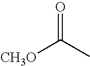

for acetic acid.

The stripping composition of the present invention can be readily prepared at room temperature without heating.

Examples of alkyl acetoacetate useful in the present invention include methyl acetoacetate (hereinafter referred to as “MAA”) and ethyl acetoacetate (hereinafter referred to as “EAA”). In lieu of acetic acid, acetic anhydride may be used.

The fatty acid amine useful in the present invention is selected from the group consisting of monoethanol amine, isopropanol amine, diethanol amine, dimethyl aminoethanol, and dimethyl ethanol amine. The glycol useful in the present invention is selected from the group consisting of ethylene glycol, monomethyl ether, monobutyl ether, butyl carbitol, ethyl carbitol, dipropylene glycol, monoethyl ether, and triethylene glycol. As a suitable polar solvent, N-methyl pyrrolidone or dimethyl sulfoxide or dimethyl acetate amide may be used.

After being prepared separately, the resist solubilizer and the solvent may be mixed to each other to give the stripping composition of the present invention. Alternatively, the stripping composition may be prepared directly from the reaction mixture obtained by reacting alkyl acetoacetate, acetic acid, and fatty acid amine in a solvent.

Having generally described this invention, a further understanding can be obtained by reference to certain specific examples which are provided herein for purposes of illustration only and are not intended to be limiting unless otherwise specified.

[Preparation of Resist Solubilizer]

### SYNTHESIS EXAMPLE 1

Synthesis of Resist Solubilizer

To a 500 mL Erlenmyer flask were charged 232.2 g of MAA and 122.16 g of monoethanol amine (hereinafter referred to as “MEA”) and the mixture was stirred for 60 min to give a viscous, yellow product of liquid phase (350 g). This was designated “reaction product A” for convenience.

### SYNTHESIS EXAMPLE 2

Synthesis of Resist Solubilizer

The procedure of Synthesis Example 1 was conducted, with the modification that 102.09 g of acetic anhydride (hereinafter referred to as “AA”), instead of MAA, was reacted with 122.16 g of MEA. 224 g of a viscous, pale yellow liquid phase resulted. This was designated “reaction product B” for convenience.

### SYNTHESIS EXAMPLE 3

Synthesis of Resist Solubilizer

The procedure of Synthesis Example 2 was conducted, with the modification that 100.0 g of acetic acid, instead of AA, was reacted with 55.0 g of MEA. 150 g of a viscous, pale yellow liquid phase resulted. This was designated “reaction product C”.

The reaction products obtained in the above synthesis examples were viscous, low volatility materials with a boiling point of 170° C. or higher.

[Preparation of Stripping Composition]

### EXAMPLE 1

12 g of the reaction product A obtained in Synthesis Example 1, 3 g of the reaction product B obtained in Synthesis Example 2, 10 g of MEA, 20 g of N-methylpyrrolidinone (1-methyl-2-pyrrolidinone, hereinafter referred to as “NMP”), and 55 g of ethyl carbitol (hereinafter referred to as “EDG”) were mixed together to give a stripping composition.

### EXAMPLE 2

8 g of MAA, 1.5 g of AA, 15.5 g of MEA, 20 g of NMP and 55 g of EDG were mixed together, followed by stirring the mixture at room temperature for 60 min to give a stripping composition.

### EXAMPLES 3 TO 16

As the same procedure of Example 1, stripping compositions for removing resist were prepared according to composition ratios shown in Table 1, below, and evaluated for strip performance according to the manners to be described below.

### EXAMPLE 17

15 g of the reaction product C obtained in Synthesis Example 3 was mixed with 81.2 g of water and 3.8 g of 98% sulfuric acid to give a stripping composition, pH 2.7.

### EXAMPLES 18 TO 22

As the same procedure of Example 17, stripping compositions for removing resist were prepared according to composition ratios shown in Table 1, below, and evaluated for strip performance according to the manners to be described below.

TABLE 1

| | Rxn | | | | | | | | | | | | | Unit. Wt % | | |
|---|---|---|---|---|---|---|---|---|---|---|---|---|---|---|---|---|
| Exmp | Product | | | | | | | | | | | | | H₂SO₄ | HNO₃ | CH₃COOH |
| No. | A | B | C | MAA | AA | MEA | NMP | EDG | DMAc | TMAH | BDG | SLN | Water | 98% | 70% | 99% |
| 1 | 12 | 3 | | | | 10 | 20 | 55 | | | | | | | | |
| 2 | | | | 8 | 1.5 | 15.5 | 20 | 55 | | | | | | | | |
| 3 | 15 | | | | | 15 | | 65 | | | | 5 | | | | |
| 4 | | | | 10 | 3 | 20 | | 67 | | | | | | | | |
| 5 | 27 | 3 | | | | | | 70 | | | | | | | | |
| 6 | | | | 15 | 3 | 20 | | 62 | | | | | | | | |
| 7 | 15 | | | | | 15 | | 70 | | | | | | | | |
| 8 | 10 | 2 | | | | 10 | 20 | 58 | | | | | | | | |
| 9 | 12 | 3 | | | | 10 | | 55 | 20 | | | | | | | |
| 10 | 30 | 3 | | | | | | 57 | | | 10 | | | | | |
| 11 | 35 | 4 | | | | 10 | 20 | 26 | 5 | | | | | | | |
| 12 | 30 | 3 | | | | 10 | | 20 | 10 | | 27 | | | | | |
| 13 | 20 | 3 | | | | 10 | 5 | 29 | 10 | | 20 | 3 | | | | |
| 14 | | | 10 | | | | | | 10 | 0.5 | | | 79.5 | | | |
| 15 | | | 10 | | | | | | 15 | 1 | | | 74 | | | |
| 16 | | | 15 | | | | | | 15 | 3 | | | 67 | | | |
| 17 | | 15 | | | | | | | | | | | 81.2 | 3.8 | | |
| 18 | | 15 | | | | | | | | | | | 79.2 | 5.8 | | |
| 19 | | 15 | | | | | | | 10 | 2 | | | 69.1 | 3.9 | | |
| 20 | 15 | | | | | | | | | | | | 80.8 | 4.2 | | |
| 21 | | | 15 | | | | | | | | | | 85.0 | | | |
| 22 | | | 15 | | | | | | | | | | 82.5 | 2.5 | | |
| C.1 | | | | | | 10 | 30 | | | | 60 | | | | | |
| C.2 | | | | | | 35 | 25 | | | | 40 | | | | | |
| C.3 | | | | | | 30 | | | | | 70 | | | | | |
| C.4 | | | | | | 20 | | | 30 | | | | 50 | | | |
| C.5 | | | | | | 15 | | 50 | | 5 | | | 30 | | | |
| C.6 | | | | | | 20 | | | | | 60 | | 20 | | | |
| C.7 | | | | | | 20 | | | | 25 | 25 | | 30 | | | |
| C.8 | | | | | | | | | | | | | 99.98 | 0.02 | | |
| C.9 | | | | | | | | | | | | | 99.97 | | 0.12 | |
| C.10 | | | | | | | | | | | | | 99.96 | | | 2.5 |

Note.
MAA: methyl acetate, AA: Acetic anhydride, MEA: Monoethanol amine, NMP: 1-Methyl-2-pyrrolidinone EDG: Ethyl carbitol, BDG: Butyl carbitol, DMAc: Dimethyl acetamide, TMAH: Tetramethyl amnmonium hydroxide (25% aq. Solution) SLN : Tetramethylene sulfone

1. Evaluation for Stripping Performance on Silicon Wafer (1)

A novolak-based positive resist for general purpose was coated onto 4-inch silicon wafers to a thickness of 1.5 mm by use of a spin coater, and baked at 110° C. for 90 sec and then at 150° C. for 5 min using a hot plate.

Subsequently, the wafer specimens thus obtained were dipped for a predetermined time in 50 ml vials containing the stripping compositions of Table 1 which were maintained at 70° C. After completion of the dipping, the specimens were removed of remaining compositions by use of an air gun, washed with isopropyl alcohol (hereinafter referred to as “IPA”) for 1 min, cleansed with ultra-pure water, and dried with an aid of an air gun. They were observed with the naked eye to determine whether or not remnants of resist were attached on the surface of wafers. The results are given in Table 2, below.

2. Evaluation for Stripping Performance on Silicon Wafer (2)

The evaluation procedure was conducted in a manner similar to that of Evaluation 1, with the modification that the removal of remaining compositions after the dipping, and the cleansing with IPA were omitted. The results are given in Table 2, below.

3. Evaluation for Stripping Performance on Glass Substrate

In the same manner as in Evaluation 2, stripping compositions were tested for stripping performance on glass substrates, each of which had a novolak-based positive resist coat atop a metal film formed to a thickness of 200 nm on its surface. To determinine whether resist remnants were attached on the substrate pattern surfaces, a scanning electron microscope (Hitachi, Japan, S-4300) was used. The evaluation results are given in Table 2, below.

4. Evaluation for Corrosion of Undercoat of Glass Substrate

Specimens with a size of 2×2 cm, made of the same glass substrate specimen as used in the previous Evaluation, were immersed in 50 ml of each stripping composition for 3, 10 and 24 hours, and observed with the naked eye to determine their corroded states. The results are given in Table 2, below. The stripping compositions were analyzed by use of Inductively Coupled Plasma-Mass Spectroscopy (ICP-MS 7500S, manufactured by Hewlett Packard) and results are given in Table 3, below.

5. Evaluation for Encroachment on Pipe

In 40 g of each stripping composition in a 50 mL vial, a polyvinyl chloride (hereinafter referred to as “clean PVC”) pipe segment of a predetermined size was immersed at room temperature (23° C.) for 1 day. After completion of the immersion, the clean PVC pipe chop was washed with IPA for 1 min and then with ultra-pure water for 3 min, followed by drying it with an air gun. Using an SEM (manufactured by Hitachi, Japan, S-4300), an examination was made of whether the striping solution encroached on the inner surface of the clean PVC pipe or not. The results are given in Table 2, below.

6. Evaluation for Encroachment on O-ring (Made of Perfluoro Ethylene)

In 30 g of each stripping composition in a 50 mL vial at 70° C., a half of an O-ring was immersed for 1 day. After completion of the immersion, the clean PVC pipe segment was washed with IPA for 1 min and then with ultra-pure water for 3 min, followed by drying it with an air gun. Using an SEM (Hitachi, Japan, S-4300), an examination was made of whether the striping solution encroached on the inner surface of the clean PVC pipe segment or not. The results are given in Table 2, below.

As apparent from Tables 2 and 3, the compositions of Examples 1 to 13 are excellent in terms of stripability, as well as showing almost no corrosion of the undercoats, Al and Mo films. Also, the compositions of Examples 3 to 6 and 16 little encroach on C-PVC pipes and O-rings.

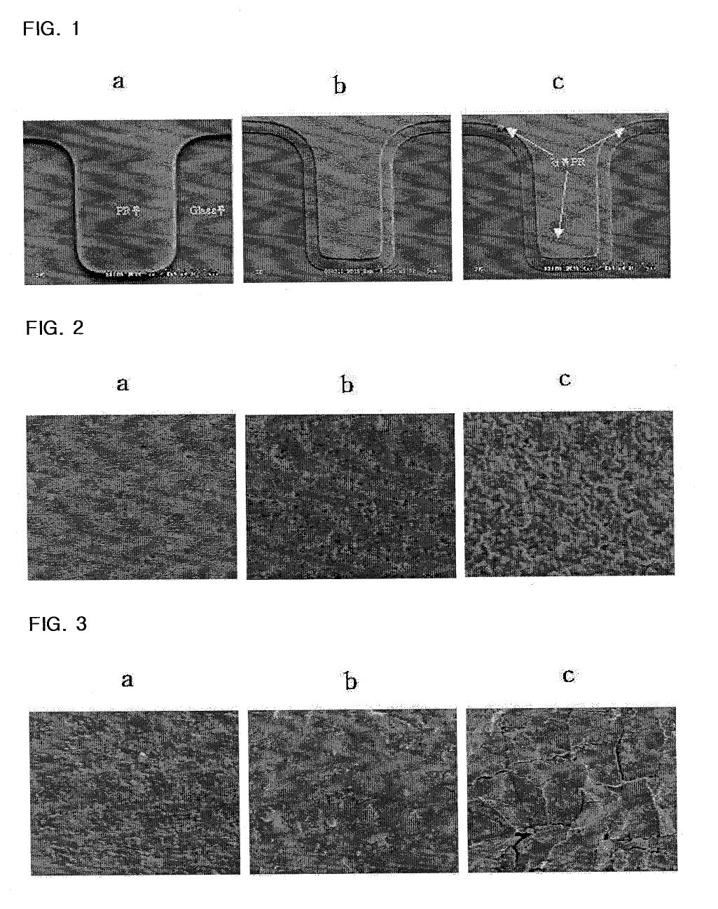

Also, results of tests using compositions of Example 1 and Comparative Examples 2 and 3 are shown in scanning electron microphotographs of FIGS. 1 to 3.

TABLE 2
Evaluation of Stripping Compositions for Stripability,
Corrosion and Encroachment

| | | | | Corrosion | | | |
|---|---|---|---|---|---|---|---|
| | | Stripability | | (24 hrs) | | Encroachment | |
| Exmp. | Evaluation | Si | | | Mo | (24 hrs) | |
| No. | No. | Wafer | Glass | Al Film | Film | C-PVC | O-ring |
| 1 | 1 | ⊚ | ⊚ | ⊚ | ⊚ | ◯ | ⊚ |
| | 2 | ⊚ | ⊚ | ⊚ | ⊚ | ◯ | ⊚ |
| 2 | 1 | ⊚ | ⊚ | ⊚ | ⊚ | ◯ | ⊚ |
| | 2 | ⊚ | ⊚ | ⊚ | ⊚ | ◯ | ⊚ |
| 3 | 1 | ⊚ | ⊚ | ⊚ | ⊚ | ⊚ | ⊚ |
| | 2 | ⊚ | ⊚ | ⊚ | ⊚ | ⊚ | ⊚ |
| 4 | 2 | ⊚ | ⊚ | ⊚ | ⊚ | ⊚ | ⊚ |
| 5 | 2 | ⊚ | ⊚ | ⊚ | ⊚ | ⊚ | ⊚ |
| 6 | 2 | ⊚ | ⊚ | ⊚ | ⊚ | ⊚ | ⊚ |
| 7 | 2 | ◯ | ⊚ | ◯ | ◯ | ◯ | ◯ |
| 8 | 2 | ◯ | ⊚ | ⊚ | ⊚ | ◯ | ◯ |
| 9 | 2 | ⊚ | ⊚ | ⊚ | ⊚ | Δ | ⊚ |
| 10 | 2 | ◯ | ⊚ | ⊚ | ⊚ | ◯ | ⊚ |
| 11 | 2 | ⊚ | ⊚ | ⊚ | ⊚ | ◯ | ⊚ |
| 12 | 2 | ◯ | ⊚ | ⊚ | ⊚ | Δ | ⊚ |
| 13 | 2 | ⊚ | ⊚ | ⊚ | ⊚ | ⊚ | ⊚ |
| C.1 | 1 | ◯ | ◯ | ◯ | Δ | Δ | Δ |
| C.2 | 1 | ⊚ | ⊚ | ◯ | Δ | Δ | Δ |
| C.3 | 1 | Δ | ◯ | ◯ | Δ | ⊚ | ⊚ |

Note:
Stripability: ⊚ excellent ◯moderate Δpoor
Corrosion: ⊚ not or slightly corroded ◯film thinned a little Xpartially corroded or no remnant films
Encroachment: ⊚ not or slightly encroached ◯somewhat encroached Δsubstantially encroached.

TABLE 3
Evaluation for Corrosion on Undercoat of Glass Substrate

| | | Immersion Time (hr) | | | |
|---|---|---|---|---|---|
| Undercoat | | 0 | 3 | 10 | 24 |
| Exmp. 1 | Al | 0 | <1.0 | 5.9 | 7.2 |
| | Mo | 0 | 3.7 | 182.9 | 1758.6 |
| C. 2 | Al | 0 | 3.0 | 6.1 | 20.1 |
| | Mo | 0 | 577.4 | 4545.0 | 15850.4 |
| C. 3 | Al | 0 | 2.8 | 6.4 | 21.5 |
| | Mo | 0 | 117.9 | 3348.4 | 11592.4 |

7. Evaluation for Stripping Performance and Corrosion on Silicon Wafer for Use in Fabrication of Semiconductor Device (1)

A general purpose, i-line or KrF positive resist was patterned on a substrate, made of an alloy of Al and Ti, for use in semiconductor processing. After etching and ashing processes, the silicon wafer substrate was diced into specimens with a size of 1.5×1.5 cm. After being immersed in 50 mL vials containing stripping compositions maintained at 30-60° C. for 10 min, the specimens were rinsed with ultra-pure water for 1 min and dried with an air gun. To determine whether resist remnants were attached on the substrate pattern surfaces and whether the stripping composition corroded the metal film, an SEM (Hitachi, Japan, S-4300) was used. The results are given in Table 4, below.

TABLE 4
Evaluation for Stripability against Resist and Corrosion of
Undercoat of Si Wafer

| | | Evaluation | | | | Corro- | |
|---|---|---|---|---|---|---|---|
| | | Temp. | | Stripability | | sion | |
| Composition | PH | (° C.) | Time (min) | Evaluation | Result | Al | Ti |
| Exmp. 14 | 4.5 | 40 | 10 | (2) | Δ | ⊚ | ⊚ |
| | | 50 | 10 | | ◯ | ⊚ | ⊚ |
| | | 60 | 10 | | ⊚ | ⊚ | ⊚ |
| Exmp. 15 | 5.0 | 60 | 10 | | ⊚ | ⊚ | ⊚ |
| Exmp. 16 | 4.2 | 60 | 10 | | ⊚ | ⊚ | ⊚ |
| Exmp. 17 | 2.7 | 35 | 10 | | ◯ | ⊚ | ⊚ |
| | | | 20 | | ⊚ | ⊚ | ⊚ |
| | | | 30 | | ⊚ | ⊚ | ⊚ |
| | | 40 | 10 | | ⊚ | ⊚ | ⊚ |
| | | | 20 | | ⊚ | ⊚ | ⊚ |
| | | | 30 | | ⊚ | ⊚ | ⊚ |
| | | 50 | 10 | | ⊚ | ⊚ | ⊚ |
| | | | 20 | | ⊚ | ⊚ | ⊚ |
| | | | 30 | | ⊚ | ⊚ | ⊚ |
| | | 55 | 10 | | ⊚ | ⊚ | ⊚ |
| | | | 20 | | ⊚ | ⊚ | ⊚ |
| | | | 30 | | ⊚ | ◯ | ⊚ |
| | | 60 | 10 | | ⊚ | ⊚ | ⊚ |
| | | | 20 | | ⊚ | Δ | ⊚ |
| | | | 30 | | ⊚ | Δ | ⊚ |
| Exmp. 18 | 2.7 | 35 | 10 | | ◯ | ⊚ | ⊚ |
| | | | 20 | | ⊚ | ⊚ | ⊚ |
| | | | 30 | | ⊚ | ⊚ | ⊚ |
| | | | 40 | | ⊚ | ⊚ | ⊚ |
| | | | 20 | | ⊚ | ⊚ | ⊚ |
| | | | 30 | | ⊚ | ⊚ | ⊚ |
| Exmp. 19 | 2.6 | 35 | 10 | | ⊚ | ⊚ | ⊚ |
| | | | 20 | | ⊚ | ⊚ | ⊚ |
| | | | 30 | | ⊚ | ⊚ | ⊚ |
| Exmp. 20 | 2.7 | 40 | 10 | | ⊚ | ⊚ | ⊚ |
| | | | 20 | | ⊚ | ⊚ | ⊚ |
| | | | 30 | | ⊚ | ⊚ | ⊚ |
| Exmp. 21 | 6.5 | 60 | 10 | | Δ | ◯ | ⊚ |
| | | | 20 | | Δ | Δ | ⊚ |
| | | | 30 | | ◯ | Δ | ⊚ |
| Exmp. 22 | 4.2 | 45 | 10 | | ◯ | ⊚ | ⊚ |
| | | | 20 | | ◯ | ⊚ | ⊚ |
| | | | 30 | | ⊚ | ⊚ | ⊚ |
| C.4 | | 60 | 10 | (1) | Δ | Δ | ⊚ |
| C.5 | | 60 | 10 | | ◯ | Δ | ⊚ |
| C.6 | | 60 | 10 | | Δ | ◯ | ⊚ |
| C.7 | | 60 | 10 | | ⊚ | Δ | ⊚ |
| C.8 | 2.7 | 40 | 10 | | ⊚ | ⊚ | ⊚ |
| | | 50 | 10 | | ⊚ | ◯ | ⊚ |
| | | | 20 | | ⊚ | Δ | ⊚ |
| | | | 30 | | ⊚ | Δ | ⊚ |
| | | 55 | 10 | | ⊚ | Δ | ⊚ |
| | | | 20 | | ⊚ | Δ | ⊚ |
| | | | 30 | | ⊚ | Δ | ⊚ |
| C.9 | 2.7 | 50 | 10 | | ◯ | ◯ | ⊚ |
| C.10 | 2.7 | 60 | 10 | | Δ | ⊚ | ⊚ |

Note.
Stripability: ⊚ excellent ◯ moderate Δpoor
Corrosion: ⊚ slightly corroded ◯ somewhat corroded Δsignificantly corroded

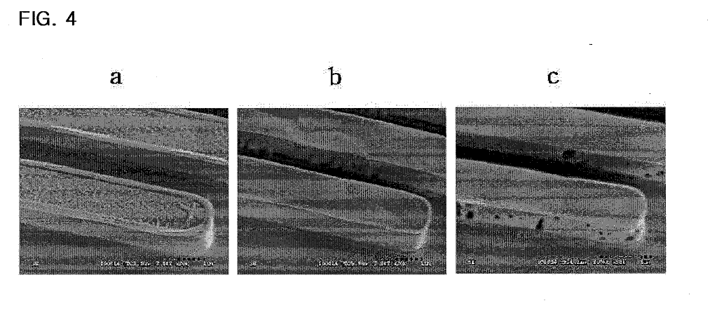

The data of Table 4 show that the stripping compositions of Examples 14 to 16 can effectively strip resists from semiconductor silicon wafers with almost no corrosion on the undercoat Al film. In this regard, evaluation results are also shown in FIG. 4, obtained using stripping compositions of Example 14 and Comparative Example 5.

As described hereinbefore, the stripping composition for removing resist of the present invention is so excellent in terms of stripability that it is only required to conduct a rinsing process with ultra-pure water without passing through a stripping composition removal process with an air knife and a rinsing process with isopropyl alcohol. Also, the stripping composition of the present invention is of low volatility and low toxicity, producing as little pollution of the environment as possible. Further, the stripping composition of the present invention enjoys the advantage of not encroaching on metal undercoats and pipe substrates such as O-rings, even without corrosion preventives.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

We claim:

1. A stripping composition for removing resist, comprising 5-50% by weight of at least one product obtained from the reaction of alkyl acetoacetate or acetic acid with fatty acid amine, and 50-95% by weight of a solvent selected from the group consisting of water, an aqueous 25 wt % tetramethyl ammonium hydroxide solution, glycol, and organic polar solvents.

2. The stripping composition as set forth in claim 1, wherein the alkyl acetoacetate is selected from the group consisting of methyl acetoacetate and ethyl acetoacetate.

3. The stripping composition as set forth in claim 1, wherein the fatty acid amine is selected from the group consisting of monoethanol amine, isopropyl amine, diethanol amine, dimethyl aminoethanol, and dimethyl ethanol.

4. The stripping composition as set forth in claim 1, wherein the glycol is selected from the group consisting of ethylene glycol monomethyl ether, ethylene glycol monobutyl ethern, butyl carbitol, ethyl carbitol, dipropylene glycol monomethyl ether, dipropylene glycol monoethyl ether, and triethylene glycol, and the organic polar solvents comprise N-methyl pyrrolidone, dimethyl sulfoxide, and dimethyl acetamide.

5. The stripping composition as set forth in claim 1, wherein the composition ranges from 0.1 to 5 in pH, adding sulfuric acid in.
